(19) United States
(12) Patent Application Publication
(10) Pub. No.: US 2006/0206364 A1
(43) Pub. Date: Sep. 14, 2006

(54) Relationship assistant

(75) Inventors: Mikko Hakala, Kauniainen (FI); Bernd Schafer, Helsinki (FI); Satu Himmanen, Espoo (FI); Jose Nederpel, Melick (NL); Tong Sun, Beijing (CN)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/083,008

(22) Filed: Mar. 14, 2005

(51) Int. Cl. G06F 9/44

(52) U.S. Cl. 705/7

(57) ABSTRACT

A relationship assistant is used in conjunction with an electronic device in order to monitor a person's communications with others. The relationship assistant gathers information from a variety of applications in order to determine whether there are particular contacts with whom the user has not recently communicated. The relationship assistant can therefore inform the user of relationships that may be languishing, as well as provide a user with a listing of the number, frequency and types of communications that have occurred.

### FIELD OF THE INVENTION

The present invention relates generally to the organization of contact information in electronic devices. More particularly, the present invention relates to the monitoring and organization of communications between a user and individual contacts of the user.

### BACKGROUND OF THE INVENTION

As people become more attached to their personal communication devices, such as cellular telephones, personal digital assistants, and other devices, they typically develop a large contact information database within their particular devices. Quite often, people will store a large number of contacts within their devices, including information such as electronic mail addresses, telephone numbers and other information.

At the same time, however, and due in part to the sheer number of contacts often stored on a single communication device, many relationships between the user and individual contacts will “fade away” over time. Over time, people fail to regularly contact each other, respond to messages, or to follow up on prior conversations. Even in very close relationships, such as with close relatives, there is a tendency for the respective relationships to suffer due to a lack of communication.

In many instances, the gradual loss of relationships can be entirely inadvertent. For example, although many mobile telephones record the phone numbers of individuals who have previously called, many “most recent called” lists will only store the most recent ten phone numbers. In this case, even if a person wishes to follow up with a person whose phone call was missed, the person may not be able to find the person's number of the “most recent called” list if the user has received several intervening phone calls. Other pieces of communications, such as short messaging service messages and electronic mail messages, though also stored on many electronic devices, will be stored in various locations on the device and scattered throughout various applications.

Given these issues, it can be quite difficult for a user to determine who he or she has not communicated with over a period of time. Some information, such as recently received telephone numbers, may be lost over time, while other information concerning recent communications tends to be widely scattered and disorganized on the device. Therefore, a person may have to perform a fairly thorough analysis of his device's contents in order to obtain a truly accurate picture of who he has not communicated with recently, or with whom communication may have been particularly one-sided. However, given the busy daily lives of most people, such an analysis is typically not feasible, which can invariably lead to the fading away of various personal relationships.

### SUMMARY OF THE INVENTION

The present invention provides for the creation of a “relationship assistant” which is capable of monitoring the persons with whom a user is communicating. The relationship assistant can gather information from a variety of applications in order to determine whether there are particular contacts with whom the user has not recently communicated. The relationship assistant can therefore inform the user of relationships that may be languishing, as well as provide a user with a listing of the number, frequency and types of communications that have occurred.

The present invention can provide a user with a number of significant benefits. A relationship assistant, according to the present invention, can automatically monitor communications and make constructive suggestions to users concerning potentially fading relationships. This can be an invaluable service in a both a person's personal and professional life, where it can be very damaging if certain relationships are allowed to atrophy. A relationship assistant of the present invention can also promote traffic and the use of content rich applications within a mobile network. The application is simple to implement and can be built on top of existing phones and applications. Furthermore, a user does not have to use the relationship assistant if so desired, and the user can also define how often the reports and suggestions are created.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1; and

FIG. 3 is a flow chart showing an implementation of one embodiment of the present invention.

### DETAILED DESCRIPTION OF THE PREFERRED EMBODIMENTS

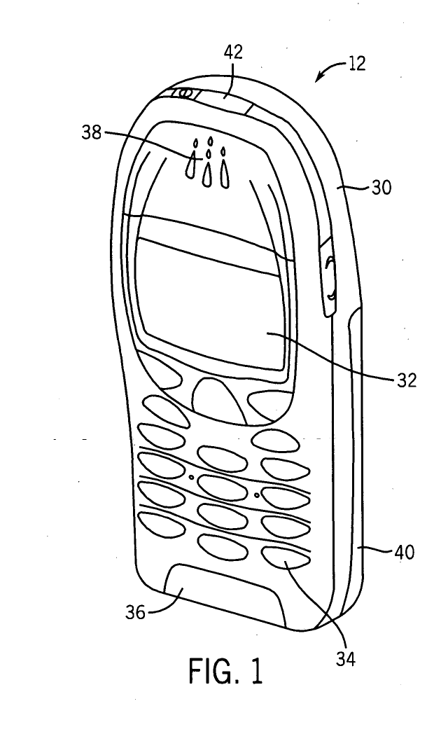

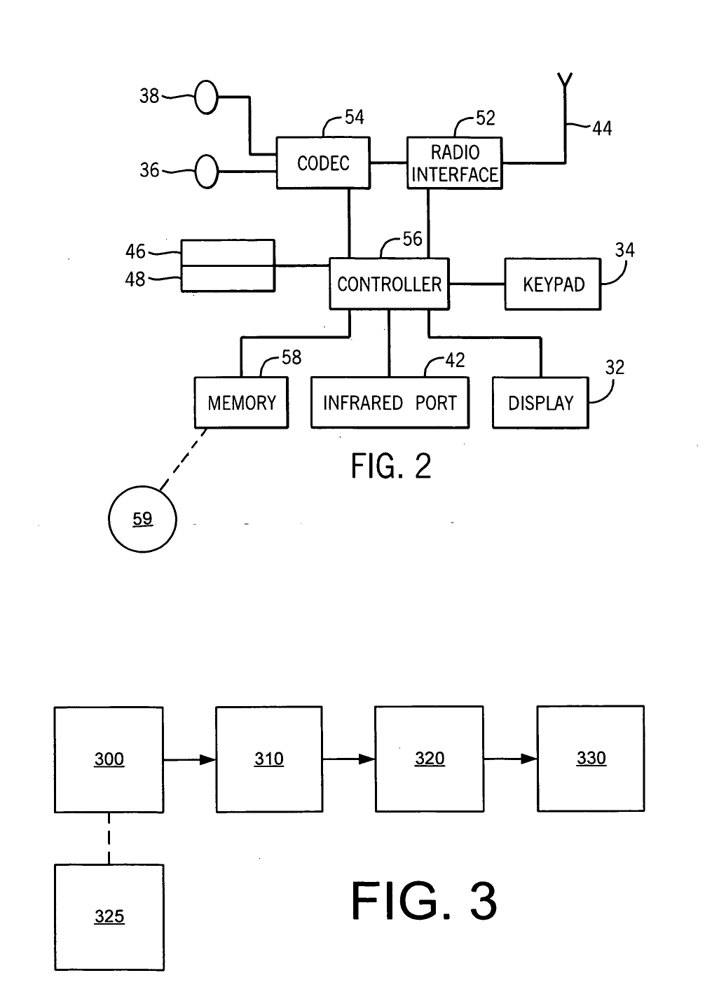

FIGS. 1 and 2 show one representative mobile telephone 12 within which the present invention may be implemented. It should be understood, however, that the present invention is not intended to be limited to one particular type of mobile telephone 12 or other electronic device. The mobile telephone 12 of FIGS. 1 and 2 includes a housing 30, a display 32 in the form of a liquid crystal display, a keypad 34, a microphone 36, a speaker 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. Individual circuits and elements are all of a type well known in the art, for example in the Nokia range of mobile telephones. Other types of electronic devices within which the present invention may be incorporated can include, but are not limited to personal digital assistants (PDAs), integrated messaging devices (IMDs), desktop computers, and notebook computers.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

As discussed above, the present invention relates to a creation of a relationship assistant that aids the user of an electronic device in maintaining strong relationships with the people who are important to him or her. The relationship assistant can take a variety of forms. For example, FIG. 2 shows the relationship assistant at 59 as an application stored within the memory 58.

The relationship assistant 59 can be a stand-alone application, or it can be integrated into another system. The relationship assistant 59 can also be transferable between devices according to one embodiment of the invention. For example, the relationship assistant 59 can be stored on a removable memory disc which can be moved from device-to-device, permitting the relationship assistant to collect information about a user's activities from different devices, such as a user's PDA and mobile telephone 12. In yet another embodiment of the invention, the relationship assistant 59 can exist on multiple devices simultaneously. For example, the relationship assistant 59 can simultaneously collect information from multiple devices in order to provide a more accurate picture of the user's communication activities. However, as discussed herein, the relationship assistant 59 is referred to as being installed on a single electronic device.

The relationship assistant 59 of the present invention keeps track of all communication that goes through the user's mobile telephone 12, as well those communications with individuals that have been classified as important by the user. The relationship assistant 59 summarizes the communications and suggests a change in behavior if various patterns are observed. For example, the relationship assistant may inform the user if communication with a certain individual is one-sided, if there is little communication in general with an individual, or if communication with an individual is not content rich (e.g., only brief SMS messages are observed.)

According to one embodiment of the present invention, the relationship assistant 59 enables the user to identify important people that are in the user's electronic device contacts/names register based upon the type of relationship. For example, a user can identify individuals as the user's employer, friend, mother, father, wife, husband, brother, etc. The user may also belong to a community whose members' relationships are determined mostly based upon electronic communication, e.g. through email mailing list activity or group gaming sessions. In one embodiment of the invention, the user can also create new categories, rename categories and/or assign contacts to various categories.

The relationship assistant 59 keeps track of communications between the user and those contacts that have been categorized. Alternatively and in one embodiment of the invention, all of the communications that pass through the device are automatically monitored and no categorization is necessary.

The relationship assistant 59 can keep track of and record various types of information with regard to the communication that is conducted on the respective electronic device. For example, the relationship assistant 59 can record the type of communication involved (such as SMS or MMS messages, electronic mail, telephone calls, video messages, instant messaging, group communication activities, etc.). The relationship assistant 59 can record the content of the communication, particularly the length of text messages, the duration time of telephone calls, the time and date at which the communication occurred, whether pictures or other images have been transmitted etc. In addition, the relationship assistant 59 can also monitor the direction of communication, e.g. whether a particular piece of communication originates with the user or with the other party or parties.

After collecting information concerning the nature and frequency of various communications, the relationship assistant 59 can create communications reports for each categorized relationship. The relationship assistant 59 can then notify a user about various aspects of particular relationships. The relationship assistant 59 can notify a user if there has been no communication with a person for an extended period of time, if communication with an individual has been one-sided, or if communications with an individual have been especially brief. For example, if a person rarely returns messages and calls from his or her mother, the relationship assistant 59 can inform the user, “Your relationship with your mother has been one-sided. Your mother has called you 10 times during the month, but you have sent her only one short text message. You have not answered five of the calls when she has tried to call you. The phone calls you have answered have only been one minute in length.”

Additionally, the relationship assistant 59 can suggest to the user ways to maintain and/or improve the relationship if so needed. For instance, and in the example discussed above, the relationship assistant 59 can inform the user “You should call your mother more often, answer her phone calls and, if necessary, say that you will call back as soon as possible.” These types of messages can be shown on the display 32 of the device, played through the speaker 38 on the device, or be exhibited in some other fashion. The messages can also be tailored in their content and frequency based upon the particular category of the individual at issue. For example, a user may be informed of a lack of communication with a close relative after only a few days of inactivity, while such notifications may be more rare for a casual acquaintance. Decisions for when such notifications are necessary are based upon predefined criteria, which may be modifiable by the user in one embodiment of the invention.

In one embodiment of the invention, communication reports and suggestions are saved as messages within an inbox on the electronic device. The communications reports can take the form of electronic mail messages, SMS messages, MMS messages, or other forms. The electronic device can notify the user whenever a new report has been created, upon regularly scheduled intervals, at the request of the user, or upon the occurrence of a particular activity (e.g., when communication occurs with a contact for the first time in a long period of time). The user may also be provided with the ability to adjust the frequency of report notifications. Additionally, and in one embodiment of the invention, the entire relationship assistant 59 is an optional feature that can be activated and deactivated by the user.

FIG. 3 is a flow chart showing the operation of a relationship assistant according to one embodiment of the present invention. At step 300, a communication takes place on the electronic device. This communication can be originated by the user or another party and can take place over a phone line, electronic mail, or virtually any other communication mechanism that can be transmitted through the particular device. At step 310, the relationship assistant 59 monitors the communication and records information concerning the communication. The recorded information can include, but is not limited to, the type of communication, the length (both in size and duration) of the communication, the other party involved, and other information. At step 320, the relationship assistant 59 generates a report based upon prior communications and according to predefined criteria. For example, software for the relationship assistant 59 can include default criteria that, if the user does not communicate with someone in the “close relative” category within seven days, this should be noted in a report. For other categories of individuals, the time period could be longer. The criteria can also relate to the frequency of communications, the lengths of communications, the types of communications, and other criteria. Alternatively, the user can program criteria into the device and/or the relationship assistant 59 for individuals, categories or communication types. This is represented at step 325. These reports can be generated on a regular basis or at the request of the user. At step 330, the relationship assistant 59 informs the user about infrequent or otherwise unusual communication patterns and makes suggestions to remedy potential situations.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques, with rule based logic, and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of assisting an individual in the maintenance of a relationship, comprising:
monitoring a plurality of communications that occur on an electronic device;
recording information concerning the nature of the plurality of communications, the information including identification of parties with whom the plurality of communications have been conducted;
generating a report regarding characteristics of communications activity between a user of the electronic device and a party based upon the recorded information and predefined criteria; and
informing the user about information contained within the report.

2. The method of claim 1, further comprising informing the user of at least one suggestion for improving communication with the party.

3. The method of claim 1, wherein the electronic device comprises a mobile telephone.

4. The method of claim 1, wherein the recorded information is selected from the group consisting of the time at which each communication takes place, the length of each communication, the format of each communication, the content of each communication, the originator of each communication and combinations thereof.

5. The method of claim 1, wherein the plurality of communications are selected from the group consisting of electronic mail messages, telephone calls, SMS messages, MMS messages, video messages, interactive group sessions and combinations thereof.

6. The method of claim 1, further comprising having the user customize the predefined criteria.

7. The method of claim 1, further comprising:
assigning a plurality of contacts stored on the electronic device to at least one of a plurality of categories; and
identifying each of the plurality of communications that involve at least one of the plurality of contacts,
wherein the generated report for the party is customized based upon the particular category assigned to the contact.

8. The method of claim 1, wherein the report is stored on the electronic device.

9. A computer program product, comprising:
computer code for monitoring a plurality of communications that occur on an electronic device;
computer code for recording information concerning the nature of the plurality of communications, the information including identification of parties with whom the plurality of communications have been conducted;
computer code for generating a report regarding characteristics of communications activity between a user of the electronic device and a party based upon the recorded information and predefined criteria; and
computer code for informing the user about information contained within the report.

10. The computer program product of claim 9, further comprising computer code for informing the user about at least one suggestion for improving communication with the party.

11. The computer program product of claim 9, wherein the recorded information is selected from the group consisting of the time at which each communication takes place, the length of each communication, the format of each communication, the content of each communication, the originator of each communication and combinations thereof.

12. The computer program product of claim 9, wherein the plurality of communications are selected from the group consisting of electronic mail messages, telephone calls, SMS messages, MMS messages, video messages, interactive group sessions and combinations thereof.

13. The computer program product of claim 9, further comprising computer code for having the user customize the predefined criteria.

14. The computer program product of claim 9, further comprising:
computer code for assigning a plurality of contacts stored on the electronic device to at least one of a plurality of categories; and
computer code for identifying each of the plurality of communications that involve at least one of the plurality of contacts,
wherein the generated report for the party is customized based upon the particular category assigned to the contact.

15. An electronic device, comprising:
a processor for processing information;
a memory unit operatively connected to the processor; and
a relationship assistant for assisting an individual in the maintenance of a relationship, the relationship operatively connected to the processor and including:
computer code for monitoring a plurality of communications that occur on an electronic device;
computer code for recording information concerning the nature of the plurality of communications, the information including identification of parties with whom the plurality of communications have been conducted;
computer code for generating a report regarding characteristics of communications activity between a user of the electronic device and a party based upon the recorded information and predefined criteria; and
computer code for informing the user about information contained within the report.

16. The electronic device of claim 15, wherein the relationship assistant further includes computer code for informing the user of at least one suggestion for improving communication with the party.

17. The electronic device of claim 15, wherein the recorded information is selected from the group consisting of the time at which each communication takes place, the length of each communication, the format of each communication, the content of each communication, the originator of each communication and combinations thereof.

18. The electronic device of claim 15, wherein the plurality of communications are selected from the group consisting of electronic mail messages, telephone calls, SMS messages, MMS messages, video messages, interactive group sessions and combinations thereof.

19. The electronic device of claim 15, wherein the relationship assistant further includes:
computer code for assigning a plurality of contacts stored on the electronic device to at least one of a plurality of categories; and
computer code for identifying each of the plurality of communications that involve at least one of the plurality of contacts,
wherein the generated report for the party is customized based upon the particular category assigned to the contact.

20. A system for assisting an individual in the maintenance of a relationship, comprising:
a processor;
a memory unit operatively connected to the processor; and
a relationship assistant including:
computer code for monitoring a plurality of communications that occur on an electronic device;
computer code for recording information concerning the nature of the plurality of communications, the information including identification of parties with whom the plurality of communications have been conducted;
computer code for generating a report regarding characteristics of communications activity between a user of the electronic device and a party based upon the recorded information and predefined criteria; and
computer code for informing the user about information contained within the report.
